(19) United States
(12) Patent Application Publication
(10) Pub. No.: US 2025/0240613 A1
(43) Pub. Date: Jul. 24, 2025

(54) SEAMLESS ROAMING PROCEDURES FOR WIRELESS NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US)

(21) Appl. No.: 19/011,415

(22) Filed: Jan. 6, 2025

Related U.S. Application Data
(60) Provisional application No. 63/623,597, filed on Jan. 22, 2024.

(51) Int. Cl. H04W 8/08

(52) U.S. Cl. CPC H04W 8/08

(57) ABSTRACT

A station (STA) in a wireless network affiliates with a seamless roaming domain in order to seamlessly roam without (re) association between one or more APs affiliated with the seamless roaming domain, whereby the seamless roaming domain architecture provides for multiple AP MLDs that interact with each other for the purpose of mobility management and includes a logical/control entity which can interact with one or more AP MLDs to enable the non-AP MLD to roam from one AP MLD to another.

### CROSS-REFERENCE TO RELATED APPLICATION(S)

This application claims the benefit of priority from U.S. Provisional Application No. 63/623,597, entitled “Seamless Roaming Procedures for Next Generation WLANS” filed Jan. 22, 2024, all of which is incorporated herein by reference in its entirety.

### TECHNICAL FIELD

This disclosure relates generally to a wireless communication system, and more particularly to, for example, but not limited to, seamless roaming procedures for wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a station (STA) in a wireless network, comprising: a memory; and a processor coupled to the memory. The processor is configured to transmit, to a first AP affiliated with a seamless roaming domain, a first frame to associate with the seamless roaming domain, wherein the seamless roaming domain communicates with one or more APs including the first AP and a second AP that are affiliated with the seamless roaming domain. The processor is configured to roam to the second AP affiliated with the seamless roaming domain, wherein the seamless roaming domain performs a context transfer from the first AP to the second AP.

In some embodiments, the context transfer transfers information related to at least one of: sequence number (SN)/packet number (PN) information, block acknowledgment agreement information, quality of service (QOS) setup information, target wake time (TWT) setup information, emergency preparedness communication service (EPCS) setup information, or traffic identifier (TID) to link mapping information.

In some embodiments, the seamless roaming domain has an identifier.

In some embodiments, the seamless roaming domain performs a data transfer from the first AP to the second AP.

In some embodiments, the processor is further configured to transmit a second frame that includes a reconfiguration message that adds a link between the STA and the second AP or deletes a link between the STA and the first AP.

In some embodiments, the processor is further configured to receive, from one or more APs affiliated with the seamless roaming domain, a second frame, advertising the seamless roaming domain.

In some embodiments, the second frame includes i) a media access control (MAC) identifier of the seamless roaming domain, ii) one or more MAC addresses of other APs that are a part of the seamless roaming domain, or iii) capabilities of other APs that are a part of the seamless roaming domain.

In some embodiments, the processor is further configured to: transmit, via the second AP, a second frame to disassociate with the seamless roaming domain.

One aspect of the present disclosure provides a first access point (AP) in a wireless network, comprising: a memory; and a processor coupled to the memory. The processor is configured to receive, from a station (STA), a first frame to associate with a seamless roaming domain with which the first AP is affiliated, wherein the seamless roaming domain communicates with one or more APs including the first AP and a second AP that are affiliated with the seamless roaming domain. The processor is configured to determine that the STA has roamed to the second AP affiliated with the seamless roaming domain and perform a context transfer to the second AP.

In some embodiments, the context transfer transfers information related to at least one of: sequence number (SN)/packet number (PN) information, block acknowledgment agreement information, quality of service (QOS) setup information, target wake time (TWT) setup information, emergency preparedness communication service (EPCS) setup information, or traffic identifier (TID) to link mapping information.

In some embodiments, the seamless roaming domain has an identifier.

In some embodiments, the seamless roaming domain performs a data transfer from the first AP to the second AP.

In some embodiments, the processor is further configured to receive a second frame that includes a reconfiguration message that adds a link between the STA and the second AP or deletes a link between the STA and the first AP.

In some embodiments, the processor is further configured to transmit, to the STA, a second frame, advertising the seamless roaming domain.

In some embodiments, the second frame includes i) a media access control (MAC) identifier of the seamless roaming domain, ii) one or more MAC addresses of other APs that are a part of the seamless roaming domain, or iii) capabilities of other APs that are a part of the seamless roaming domain.

One aspect of the present disclosure provides a computer-implemented method for communication by a station (STA) in a wireless network. The method comprises transmitting, to a first AP affiliated with a seamless roaming domain, a first frame to associate with the seamless roaming domain, wherein the seamless roaming domain communicates with one or more APs including the first AP and a second AP that are affiliated with the seamless roaming domain. The method comprises roaming to the second AP affiliated with the seamless roaming domain, wherein the seamless roaming domain performs a context transfer from the first AP to the second AP.

In some embodiments, the context transfer transfers information related to at least one of: sequence number (SN)/packet number (PN) information, block acknowledgment agreement information, quality of service (QOS) setup information, target wake time (TWT) setup information, emergency preparedness communication service (EPCS) setup information, or traffic identifier (TID) to link mapping information.

In some embodiments, the seamless roaming domain has an identifier.

In some embodiments, the seamless roaming domain performs a data transfer from the first AP to the second AP.

In some embodiments, the method further comprises transmitting a second frame that includes a reconfiguration message that adds a link between the STA and the second AP or deletes a link between the STA and the first AP.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates stages of a mobility handover procedure in accordance with an embodiment.

FIG. 5 illustrates a roaming architecture that includes a parallel stack in accordance with an embodiment.

FIG. 6 illustrates a flow chart of an example process of associating with a seamless roaming domain in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

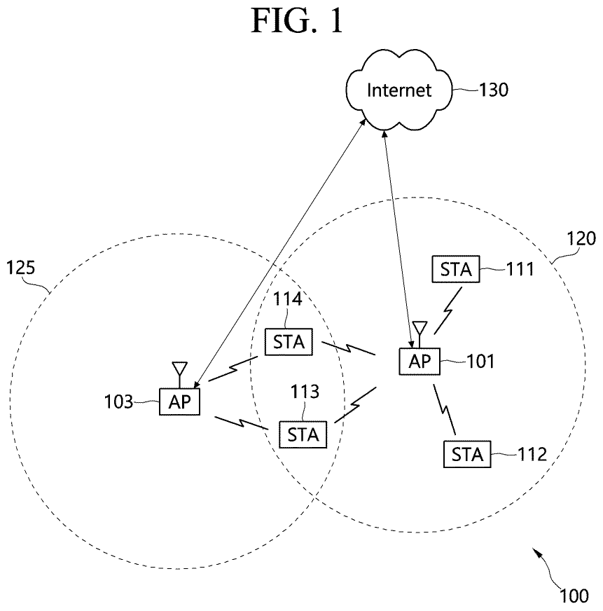

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

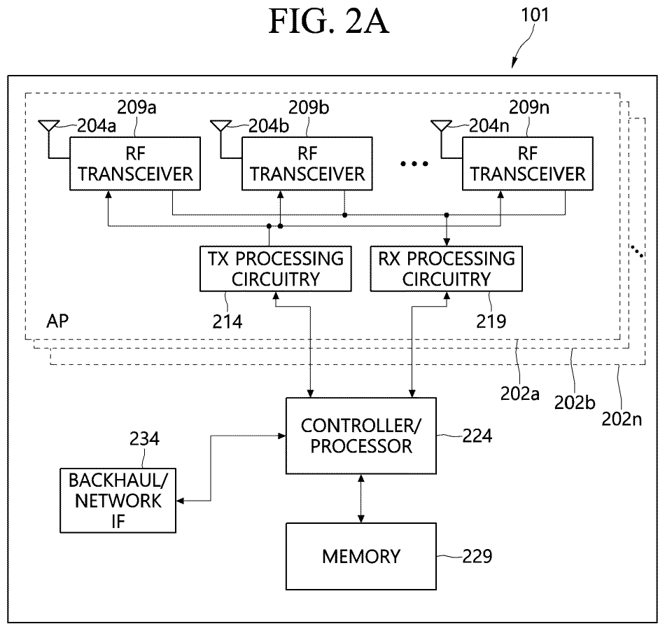

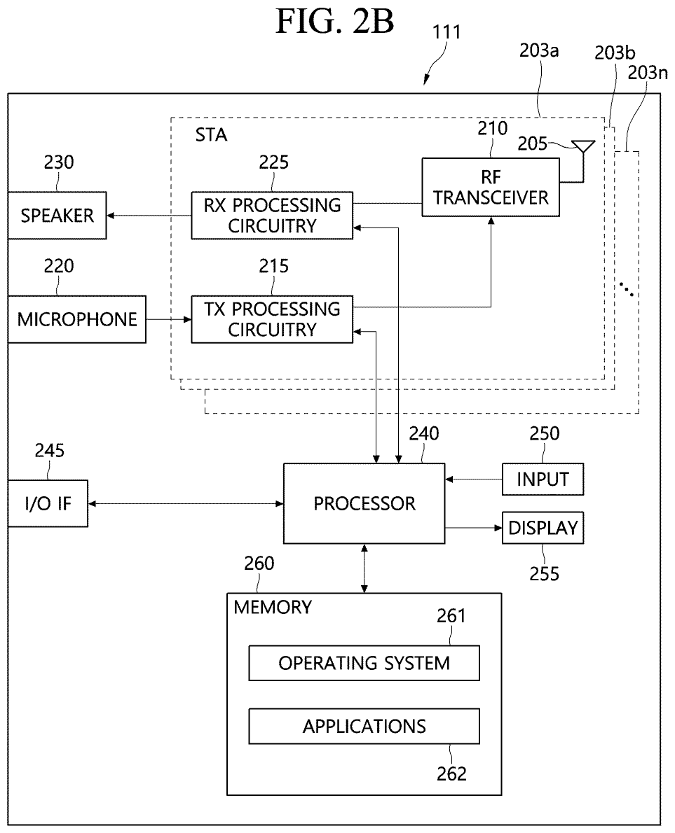

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

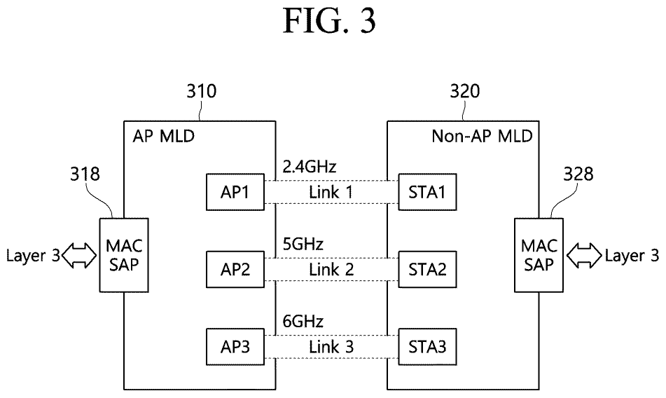

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and ii) IEEE P802.11be/D4.0, “Wireless LAN Medium Access Control (MAC) and Physical Layer (PHY) Specifications.”

As users move around an environment while holding an STA device, a signal strength of the STA to its connected AP can vary. If a user movement causes a significant decrease in a signal strength, a handover may be necessary. During the process of handover, an STA may switch from its current associated AP to a new AP.

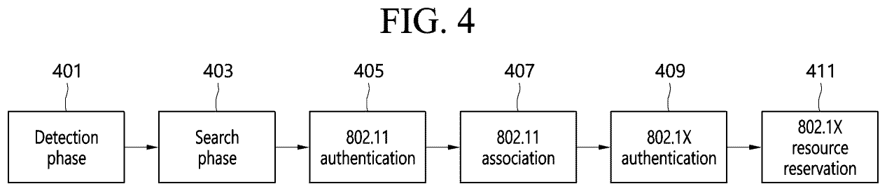

FIG. 4 illustrates stages of a mobility handover procedure in accordance with an embodiment. As shown in FIG. 4, in legacy devices without any mobility support, the handover procedure may involve several steps, including a detection phase 401, a search phase 403, an 802.11 authentication phase 405, an 802.11 association phase 407, an 802.1X authentication phase 409, and a 802.11 resource reservation phase 411.

During the detection phase 401, an STA may determine that there is a need for a handover. The procedures to detect a need for handover may be vendor specific. For instance, a particular vendor implementation can choose to trigger handover when the signal strength to the currently associated AP drops below a certain threshold.

The detection phase 401 may be followed by a search phase 403. During the search phase 403, the STA may search for new APs to associate with. During the search phase 403, the STA may perform a scan of different channels to identify APs in the vicinity. This can be done either passively, for example, by listening to beacons on a particular channel, or actively, for example, by the use of probe request and response procedure.

After the scanning procedure is complete, the next step is to perform 802.11 authentication (open system/shared key based) 405. Once the STA is authenticated, the next step is to perform 802.11 association 807. Introduced in IEEE 802.1i amendment, the 802.1X authentication phase 409 may include an EAP authentication between the STA and a AAA server with the assistance of the AP. Finally, during the 802.11 resource reservation phase 411, the STA may set up various resources at the new AP. For example, the STA can perform QoS reservation, BA setup, among other operations with the newly associated AP.

Typically, during a handover, there can be a disruption in the connection as the setup procedure operates in a break-before-make manner. This can cause an impact on user experience especially with multimedia services which can suffer from session disruptions due to the high delay encountered during handover procedure.

In order to reduce the handover delay, a number of procedures have been introduced in several standards. The focus of these procedures may be to remove or reduce the delay encountered in various steps of the handover procedure. In 2008, IEEE 802.11r standard introduced a fast transition roaming which may eliminate the need for the authentication step during the handover. In 2011, IEEE 802.11k introduced assisted roaming which reduces the search phase by allowing the STA to request the AP to send channel information of candidate neighbor APs. In 2011, IEEE 802.11v also introduced network assisted roaming to assist the search phase. In IEEE 802.11be, the fast BSS transition procedure was extended to cover the case of MLO operation. This procedure helps to reduce the delays encountered due to 802.11 resource reservation. However, the STA may still need to perform the association and authentication phases which can take e.g., 10s of ms.

In some embodiments, a roaming architecture can be utilized where multiple AP MLDs can interact with each other for the purpose of mobility management. The architecture can include a logical control entity which can interact with one or more AP MLDs to enable the non-AP MLD to roam from one AP MLD to another AP MLD. The logical control entity may be referred to herein as a parallel stack, a seamless mobility domain entity, among other terms.

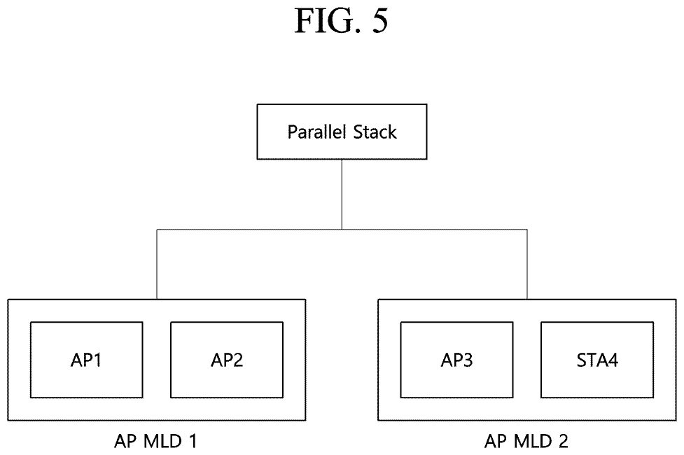

FIG. 5 illustrates a roaming architecture that includes a parallel stack in accordance with an embodiment. In particular, FIG. 5 illustrates AP MLD1 that includes AP1 an AP2, and AP MLD2 that includes AP3 and AP4. The parallel stack (e.g., logical control entity, seamless roaming domain entity) can provide support for operations that may be necessary for roaming from one AP MLD to another AP MLD.

In some embodiments, the logical control entity can perform one or more operations, including association handling, security parameters handling, operation parameter setup, disassociation handling, context transfer handling, roaming handling, and/or authentication handling, among various other operations.

In some embodiments, the logical control entity can have its own identifier. In some embodiments, the logical control entity can have its own media access control (MAC) address as an identifier. In some embodiments, the process of roaming from one AP MLD to another AP MLD can include a context transfer with or without a data transfer (e.g., data forwarding, data path transfer, among other operations). In some embodiments, a context transfer can be achieved by transferring the contexts from one AP MLD to another AP MLD. In certain embodiments, a context transfer may be performed by moving the logical control entity from one AP MLD to another AP MLD. In some embodiments, the non-AP MLD can perform authentication and association with the logical control entity by communicating with the AP MLDs that the logical control entity interacts with. Once the links are setup, the non-AP MLD can roam from one AP MLD to another AP MLD. In some embodiments, the roaming may include performing multi-link (ML) reconfiguration procedures that may add or delete links as the non-AP MLD roams between AP MLDs.

In some embodiments, the AP MLDs that the logical control entity interacts with can advertise the presence of the logical control entity in their advertisement messages. These advertisement messages can include but are not limited to information that is exchanged via management frames such as beacons, probe responses, among other frames. These advertisement messages can enable the non-AP MLDs to be able to discover the logical control entity's presence. This can be useful information for the non-AP MLD. For example, if the non-AP MLD has a preference to associate with an AP MLD that supports seamless roaming. In such a situation, this advertisement can enable the non-AP MLD to discover the support and make use of it during roaming by initiating or participating in necessary roaming procedures. In some embodiments, the advertisement message can include at least one or more of the information items as indicated in Table 1.

TABLE 1

| Information | |
|---|---|
| items | Description |
| Logical control | An information item(s) that can |
| entity identifier | identify the logical control entity. e.g., |
| | MAC address. |
| Presence | An information item(s) that can indicate |
| indicator | that there is a logical control |
| | entity that interacts with the AP |
| | MLD for the purpose of seamless |
| | mobility support. e.g., a bit or flag that |
| | can take a predetermined value to |
| | make the indication. |
| Other AP | An information item(s) that can indicate |
| MLD(s) info | other AP MLD(s) that are a part |
| | of the setup. e.g., other AP MLD(s) |
| | MAC address, basic service set |
| | identifier (BSSID), among others. |
| Other AP | An information item(s) that can |
| MLD(s) | describe the capabilities of other AP |
| capability info | MLD(s). These can include but are |
| | not limited to MAC and/or PHY |
| | capabilities. e.g., features supported, |
| | operation constraints, operation |
| | frequency, bandwidth, channel, |
| | supported rates, among others. |

The above information items can be transmitted together or separately. They can be transmitted as a part of any existing frame/element/field/subfield in the standard or can be a part of newly defined ones.

In some embodiments, the non-AP MLD can perform association and authentication with the logical control entity. Thus, as a non-AP MLD roams from one AP MLD to another AP MLD, a (Re) association may not be needed. When the non-AP MLD performs association and/or authentication, it can transmit a message that can include at least one or more of the information items as indicated in Table 2.

TABLE 2

| Information | |
|---|---|
| item | Description |
| Logical control | An information item that can indicate |
| entity association | the intent to connect with the |
| intent indication | logical control entity. e.g., a bit or |
| | flag that can take a predetermined |
| | value to make the indication. |
| Logical control | An information item(s) that can |
| entity identifier | identify the logical control entity. e.g., |
| | MAC address. This can help to |
| | understand what logical control entity |
| | the non-AP MLD wants to connect to. |

The above information items can be transmitted together or separately. They can be transmitted as a part of any existing frame/element/field/subfield in the standard or can be a part of newly defined ones.

In some embodiments, once the non-AP MLD connects to a logical control entity, it can be assigned an identifier, for example, an association identifier (AID). This AID can remain the same during the course of the non-AP MLDs association or it can be modified as the non-AP MLD roams from one AP MLD to another AP MLD.

Dissociation procedures in accordance with this disclosure are described herein. In some embodiments, during disassociation, the disassociation message can include one or more of the information items as shown in Table 3.

TABLE 3

| Information | |
|---|---|
| item | Description |
| Logical control | An information item that can indicate |
| entity | the intent to disconnect with the |
| disassociation | logical control entity. e.g., a bit or |
| intent indication | flag that can take a predetermined |
| | value to make the indication. |
| Logical control | An information item(s) that can |
| entity identifier | identify the logical control entity. e.g., |
| | MAC address. This can help to |
| | understand what logical control entity |
| | the non-AP MLD wants to disconnect from. |
| Disconnection | An information item(s) that can |
| time | indicate the time at which the |
| | disconnection can occur. e.g., the |
| | number of target beacon transmission |
| | times (TBTTs) from the current TBTT |
| | at which the disconnection can |
| | occur. |

The above information items can be transmitted together or separately. They can be transmitted as a part of any existing frame/element/field/subfield in the standard or can be a part of newly defined ones.

Roaming procedures in accordance with this disclosure are described herein. In some embodiments, during roaming, a reconfiguration procedure can be performed. As a part of the reconfiguration procedure, one or more link(s) can be added to the non-AP MLD's setup and one or more link(s) can be deleted from the non-AP MLD's setup. In some embodiments, the reconfiguration can be performed either by the non-AP MLD or by the AP MLD by transmitting a reconfiguration message. The reconfiguration message can include at least one or more of the information items as indicated in Table 4.

TABLE 4

| Information | |
|---|---|
| items | Description |
| Current link | An information item(s) that can describe |
| configuration | the current link configuration. |
| | e.g., the link IDs |
| Current AP | An information item(s) that can describe |
| identifier | the current AP identifier. e.g., |
| | the AP MLD MAC address, service |
| | set identifier (SSID), basic service |
| | set identifier (BSSID), among others. |
| New link | An information item(s) that can describe |
| configuration | the new link configuration. e.g., |
| | link IDs. |
| Target AP(s) | An information item(s) that can describe |
| identifier | the target AP(s). e.g., the AP |
| | MLD MAC address, SSID, BSSID, |
| | among others. |
| Timing | An information item(s) that can describe |
| information | the timing information for the |
| | roaming. e.g., the number of TBTTs from |
| | the current TBTT at which the |
| | roaming can occur. |

The above information items can be transmitted together or separately. They can be transmitted as a part of any existing frame/element/field/subfield in the standard or can be a part of newly defined ones.

Upon receiving the reconfiguration message, the recipient can process the above message and can either directly initiate a roaming procedure or can send a response message back to the non-AP MLD. The response message can include at least one or more of the information items as described in Table 5.

TABLE 5

| Information | |
|---|---|
| items | Description |
| Current link | An information item(s) that can describe |
| configuration | the current link configuration. |
| | e.g., the link IDs |
| Current AP | An information item(s) that can describe |
| identifier | the current AP identifier. e.g., |
| | the AP MLD MAC address, SSID, |
| | BSSID, among others. |
| New link | An information item(s) that can describe |
| configuration | the new link configuration. e.g., |
| | link IDs. |
| Target AP | An information item(s) that can |
| identifier | describe the target AP. e.g., the AP |
| | MLD MAC address, SSID, BSSID, among others. |
| Timing | An information item(s) that can describe |
| information | the timing information for the |
| | roaming. e.g., the number of TBTTs |
| | from the current TBTT at which the |
| | roaming can occur. |

The above information items can be transmitted together or separately. They can be transmitted as a part of any existing frame/element/field/subfield in the standard or can be a part of newly defined ones.

In some embodiments, in order for a non-AP MLD to roam from one AP MLD to another AP MLD, there can be a context transfer procedure. In certain embodiments, for roaming, there may be a context transfer that is also accompanied by a data transfer procedure. In some embodiments, the roaming may also make use of a modified ML reconfiguration procedure that can add links from another AP MLD.

Context transfer procedures in accordance with this disclosure are described herein. In some embodiments, when a non-AP MLD transfers from one AP MLD to another AP MLD, one or more of the contexts at the current AP MLD can be transferred to the target AP MLD. These contexts can include but not be limited to the items described in Table 6.

TABLE 6

| Information | |
|---|---|
| item | Description |
| SN/PN | Sequence number (SN)/packet number |
| information | (PN) information. e.g., this can |
| | be the last used SN/PN from the |
| | current AP that can be transferred to |
| | the new AP. |
| Block ACK | One or more parameters related to |
| agreement | the block acknowledgement (BA) |
| parameters | agreement. |
| QoS setups | One or more parameters related to |
| | quality of service (QoS) setups. |
| TWT setups | One or more parameters related to |
| | target wake time (TWT) setups. |
| EPCS setups | One or more parameters related |
| | to emergency preparedness |
| | communication service (EPCS) setups. |
| TID to link | One or more parameters related |
| mapping | to traffic identifier (TID) to link |
| | mapping. |

The above information items can be transmitted together or separately. They can be transmitted as a part of any existing frame/element/field/subfield in the standard or can be a part of newly defined ones.

Context transfers in accordance with this disclosure are described herein In some embodiments, a context transfer can be completely performed at once. Thus, all the parameters can be transferred from one AP MLD to another AP MLD. In certain embodiments, a context transfer may be performed in parts. In particular, a part of a context transfer can be performed after roaming is initiated to setup the target AP MLD with the required parameters. For example, the part of the context transfer can be with respect to BA agreements, EPCS setups, among others. A remaining part of the context transfer can be transferred at a later point in time. For example, the remaining part may be related to SN/PN information, among others.

Data handling procedures in accordance with this disclosure are described herein. In some embodiments, during roaming, a data path can be switched from the current AP MLD to the target AP MLD. In some embodiments, the data path can be switched after a context transfer is completed. In certain embodiments, during the roaming procedure, one or more frames for the non-AP MLD can still be buffered at the original AP MLD. These frames can be handled in one or more techniques as follows. In some embodiments, a continuation of transmission may be performed whereby the current AP MLD can continue to transmit the buffered frames to the non-AP MLD until the buffer is empty. In certain embodiments, a transfer of data frames to the new or target AP MLD may be performed whereby the current AP MLD can forward the frames to the target AP MLD. In some embodiments, a clear buffer without transmission may be performed whereby the current AP MLD can drop the frames and not perform the transmission of the buffered frames to the non-AP MLD or the forwarding of the frames to the target AP MLD. In some embodiments, a hybrid mode may be performed whereby the current AP MLD can forward some frames to the target AP MLD and drop some frames. For example, the current AP MLD may forward frames of latency sensitive traffic and drop the frames of latency tolerant traffic. In some embodiments, for uplink frame transmission, the non-AP MLD can transmit the uplink frames to the target AP MLD after the roam occurs and all the following frames may be transmitted to the target AP MLD.

Security handling in accordance with this disclosure is described herein. In some embodiments, security related parameters can be generated by using the parameters of the logical control entity instead of the AP MLD, including, for example, the logical control entity MAC address. In some embodiments, security parameters that don't have a link dependency can, thus, remain the same as the non-AP MLD roams from one AP MLD to another AP MLD. In some embodiments, security parameters that have a link dependency can be provided to the non-AP MLD after the new links are added.

Link management in accordance with this disclosure is described herein. In some embodiments, in order to avoid confusion over the link IDs that are indicated in signaling to the logical control entity, the link IDs can be coupled with one or more other parameters to differentiate the links. The one or more other parameters may include, for example, the AP MLD MAC address, BSSID, among others. In some embodiments, the AP MLDs can be assigned AP MLD IDs by the logical control entity and these IDs can be used for making the differentiation.

Capability advertisement in accordance with this disclosure is described herein. In some embodiments, an AP MLD that can provide support seamless roaming procedures can advertise the capability in one or more frames that it transmits, including for example, management frames such as beacons, probe responses, among others. This can enable the non-AP MLD to discover the capability and connect to the desired AP MLD. The advertisement can be performed by including an information item that can describe the capability, including for example a bit or flag that can take a predetermined value to make the indication.

In some embodiments, a non-AP MLD can make an advertisement of the capability to support seamless roaming procedures in one or more frames that it transmits, including for example, management frames such as probe requests, (Re) association requests, among others. This can enable the AP MLD to understand the non-AP MLD's capability and initiate the necessary procedures during roaming. Although the procedures described herein in this disclosure are described in the context of MLO operation, they can apply to single link operations as well.

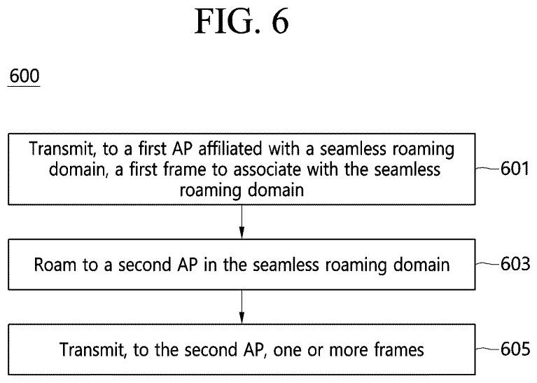

FIG. 6 illustrates a flow chart of an example process performed by an STA of associating with a seamless roaming domain (SRD) in accordance with an embodiment. Although one or more operations are described or shown in particular sequential order, in other embodiments the operations may be rearranged in a different order, which may include performance of multiple operations in at least partially overlapping time periods. The flowchart depicted in FIG. 6 illustrates operations performed in an STA, such as the STA illustrated in FIG. 3.

The process 600, in operation 601, the STA, transmits to an AP affiliated with a seamless roaming domain, a first frame that indicates an intent to associate with the seamless roaming domain. In some embodiments, the first frame can include or more information items set out in Table 2 above.

In operation 603, STA roams to a second AP affiliated with the seamless roaming domain. In some embodiments, during roaming, a reconfiguration procedure can be performed. As a part of the reconfiguration procedure, one or more link(s) can be added to the non-AP MLD's setup and one or more link(s) can be deleted from the non-AP MLD's setup. In some embodiments, the reconfiguration can be performed either by the non-AP MLD or by the AP MLD by transmitting a reconfiguration message. The reconfiguration message can include at least one or more of the information items as indicated in Table 4.

In some embodiments, in order for a non-AP MLD to roam from one AP MLD to another AP MLD, there can be a context transfer procedure. In certain embodiments, for roaming, there may be a context transfer that is also accompanied by a data transfer procedure. In some embodiments, the roaming may also make use of a modified ML reconfiguration procedure that can add links from another AP MLD. In some embodiments, when a non-AP MLD transfers from one AP MLD to another AP MLD, one or more of the contexts at the current AP MLD can be transferred to the target AP MLD. These contexts can include but not be limited to the items described in Table 6.

In operation 605, the STA transmits to the second AP one or more frames.

Embodiments in accordance with this disclosure providing for seamless roaming whereby a non-AP MLD may switch from one AP MLD to a different AP MLD without disruption in a connection, providing an improve user experience especially with multimedia services which can suffer from session disruptions due to the high delay encountered during existing handover procedure.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, comprising:
a memory; and
a processor coupled to the memory, the processor configured to:
transmit, to a first AP affiliated with a seamless roaming domain, a first frame to associate with the seamless roaming domain, wherein the seamless roaming domain communicates with one or more APs including the first AP and a second AP that are affiliated with the seamless roaming domain; and
roam to the second AP affiliated with the seamless roaming domain, wherein the seamless roaming domain performs a context transfer from the first AP to the second AP.

2. The STA of claim 1, wherein the context transfer transfers information related to at least one of: sequence number (SN)/packet number (PN) information, block acknowledgment agreement information, quality of service (QOS) setup information, target wake time (TWT) setup information, emergency preparedness communication service (EPCS) setup information, or traffic identifier (TID) to link mapping information.

3. The STA of claim 1, wherein the seamless roaming domain has an identifier.

4. The STA of claim 1, wherein the seamless roaming domain performs a data transfer from the first AP to the second AP.

5. The STA of claim 1, wherein the processor is further configured to:
transmit a second frame that includes a reconfiguration message that adds a link between the STA and the second AP or deletes a link between the STA and the first AP.

6. The STA of claim 1, wherein the processor is further configured to:
receive, from one or more APs affiliated with the seamless roaming domain, a second frame, advertising the seamless roaming domain.

7. The STA of claim 6, wherein the second frame includes i) a media access control (MAC) identifier of the seamless roaming domain, ii) one or more MAC addresses of other APs that are a part of the seamless roaming domain, or iii) capabilities of other APs that are a part of the seamless roaming domain.

8. The STA of claim 1, wherein the processor is further configured to:
transmit, via the second AP, a second frame to disassociate with the seamless roaming domain.

9. A first access point (AP) in a wireless network, comprising:
a memory; and
a processor coupled to the memory, the processor configured to:
receive, from a station (STA), a first frame to associate with a seamless roaming domain with which the first AP is affiliated, wherein the seamless roaming domain communicates with one or more APs including the first AP and a second AP that are affiliated with the seamless roaming domain; and
determine that the STA has roamed to the second AP affiliated with the seamless roaming domain and perform a context transfer to the second AP.

10. The AP of claim 9, wherein the context transfer transfers information related to at least one of: sequence number (SN)/packet number (PN) information, block acknowledgment agreement information, quality of service (QOS) setup information, target wake time (TWT) setup information, emergency preparedness communication service (EPCS) setup information, or traffic identifier (TID) to link mapping information.

11. The AP of claim 9, wherein the seamless roaming domain has an identifier.

12. The AP of claim 9, wherein the seamless roaming domain performs a data transfer from the first AP to the second AP.

13. The AP of claim 9, wherein the processor is further configured to:
receive a second frame that includes a reconfiguration message that adds a link between the STA and the second AP or deletes a link between the STA and the first AP.

14. The AP of claim 9, wherein the processor is further configured to:
transmit, to the STA, a second frame, advertising the seamless roaming domain.

15. The AP of claim 14, wherein the second frame includes i) a media access control (MAC) identifier of the seamless roaming domain, ii) one or more MAC addresses of other APs that are a part of the seamless roaming domain, or iii) capabilities of other APs that are a part of the seamless roaming domain.

16. A computer-implemented method for communication by a station (STA) in a wireless network, comprising:
transmitting, to a first AP affiliated with a seamless roaming domain, a first frame to associate with the seamless roaming domain, wherein the seamless roaming domain communicates with one or more APs including the first AP and a second AP that are affiliated with the seamless roaming domain; and
roaming to the second AP affiliated with the seamless roaming domain, wherein the seamless roaming domain performs a context transfer from the first AP to the second AP.

17. The computer-implemented method of claim 16, wherein the context transfer transfers information related to at least one of: sequence number (SN)/packet number (PN) information, block acknowledgment agreement information, quality of service (QOS) setup information, target wake time (TWT) setup information, emergency preparedness communication service (EPCS) setup information, or traffic identifier (TID) to link mapping information.

18. The computer-implemented method of claim 16, wherein the seamless roaming domain has an identifier.

19. The computer-implemented method of claim 16, wherein the seamless roaming domain performs a data transfer from the first AP to the second AP.

20. The computer-implemented method of claim 16, further comprising transmitting a second frame that includes a reconfiguration message that adds a link between the STA and the second AP or deletes a link between the STA and the first AP.
